(19) United States
(12) Patent Application Publication
(10) Pub. No.: US 2013/0000381 A1
(43) Pub. Date: Jan. 3, 2013

(54) Impact Generating Unit and Impact Generating Assembly Comprising the Same

(76) Inventor: Kun Ta Lee, Taipei Hsien (TW)

(21) Appl. No.: 13/269,711

(22) Filed: Oct. 10, 2011

(30) Foreign Application Priority Data
Jun. 28, 2011 (TW) 100122673

(51) Int. Cl. G01N 3/00

(52) U.S. Cl. 73/12.09

(57) ABSTRACT

An impact generating assembly comprises an impact platform and a plurality of impact generating units is provided. Each of the impact generating units comprises a holder portion, a fixture device and an impact generating portion. The holder portion comprises a first inclined plane and a second inclined plane opposite the first inclined plane. The fixture device is disposed on the holder portion. The impact generating portion is disposed on the holder portion for providing a reciprocating motion. Each of the impact generating units is mounted to the impact platform by the fixture device, and the impact generating portion is adapted to produce a synchronous vibration on the impact platform through the impact platform.

This application claims priority to Taiwan Patent Application No. 100122673 filed on Jun. 28, 2011.

### CROSS-REFERENCES TO RELATED APPLICATIONS

Not applicable.

### BACKGROUND OF THE INVENTION

1. Field of the Invention

The present invention relates to an impact generating unit and an impact generating assembly comprising the same; and more particularly, the present invention relates to an impact generating unit that is adapted to be utilized on an impact platform or an object to be impacted and also be detached and assembled easily.

2. Descriptions of the Related Art

With the advent of various electronic products, the specifications and industrial standards of these products have also become increasingly stricter. Among others, the reliability tests of products themselves are known as indispensable procedures to be carried out before the rollout of electronic products. The reliability tests not only help to estimate the warranted period of the product and resistance level that could be endured during transportation, but may also help to point out the weak points in the structure of the products in the early stage of the research and development (R&D) phase. Among various ways to carry out the reliability tests, one of the most commonly used ways is the impact test.

Conventionally, most impact testing devices have an impact generating unit which is fixed to an impact platform, and a test object such as an electronic product is fixed to the impact platform to be subjected to the impacting test.

As shown in FIG. 1, a conventional impact generating assembly 1 for carrying out an impact testing comprises an impact platform 12 and an impact generating portion 14 with a specific inclined angle. The impact generating portion 14 is welded or otherwise fixed under the impact platform 12 to form an undetachable structure. Then, after a test object 16 is fixed to the impact platform 12 by means of a belt or a fixing strap, a reciprocating motion can be produced by the impact generating portion 14 to drive the impact platform 12, which provides an impacting force against the test object 16 in a specific direction.

This kind of impacting test device is widely spread and utilized in the industry because of its low cost. However, this kind of design is limited in generating an impacting force in a single invariable direction. Therefore, if a user desires to change the impacting direction or angle, a different impact generating assembly must be applied and purchased. These extra steps are not only inconvenient, but also increase the overall cost of the testing procedure.

In view of this, an impact unit that has an easy assembly and detachment is provided in the present invention. The impact generating unit could be adjusted into different angles depending on the desired impacting directions; the impact testing can then be customized and the testing cost can be decreased.

### SUMMARY OF THE INVENTION

An objective of the present invention is to provide an impact generating unit and an impact generating assembly that allows for easy assembly and detachment so that the impact generating unit can be easily adjusted into different impacting angles or directions depending on the testing requirements. Furthermore, since the impact generating unit is detachable, the different impact generating units can be applied on the impact generating assembly to provide a more flexible usage of the impact generating unit and save the cost of purchasing a number of impact generating assemblies.

To achieve the aforesaid objective, the impact generating assembly of the present invention comprises an impact platform and a plurality of impact generating units. Each of the impact generating units comprises a holder portion, a fixture device and an impact generating portion. The holder portion further comprises a first inclined plane and a second inclined plane opposite the first inclined plane. The fixture device is disposed on the holder portion, and may be a tenon joint or a structure with a buckling or screwing function that is adapted to mount the impact generating unit to the impact platform. The impact generating portion is disposed on the holder portion, and may be an electromagnetic hammer applying an impacting force in a specific direction according to the electromagnetic induction principle. The impact generating portion may also be a micro vibration motor; the impacting frequency and the impacting force can be adjustably controlled by the micro vibration motor depending on the use. Furthermore, the impact generating units are not limited to a vertical orientation, but may be modified into different orientations depending on the user's requirements.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional impact testing device;

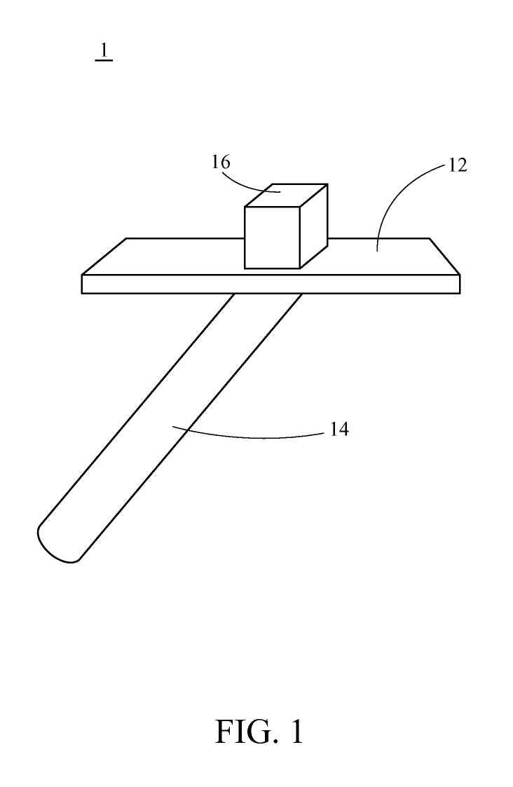

FIG. 2 is a schematic view of a first embodiment of the present invention;

FIG. 3 is an exploded view of the first embodiment of the present invention;

FIG. 4 is a schematic view of another example of the impact generating unit according to the first embodiment of the present invention;

FIG. 5 is an exploded view of a second embodiment of the present invention;

FIG. 6 is a schematic view of a third embodiment of the present invention;

FIG. 7 is an exploded view of the third embodiment of the present invention;

FIG. 8 is a top view of a fourth embodiment of the present invention;

FIG. 9 is a top view of a fifth embodiment of the present invention; and

FIG. 10 is a top view of a sixth embodiment of the present invention.

### DESCRIPTION OF THE PREFERRED EMBODIMENT

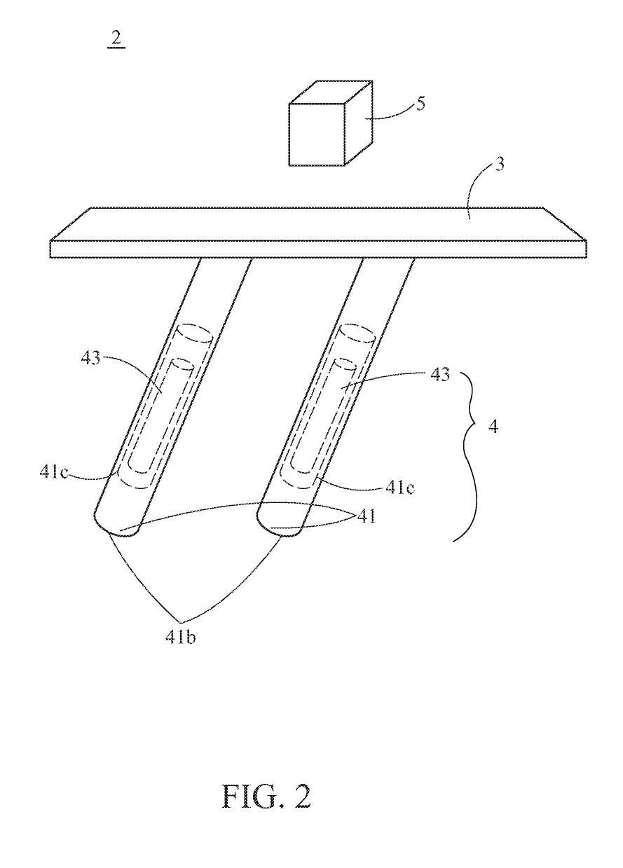

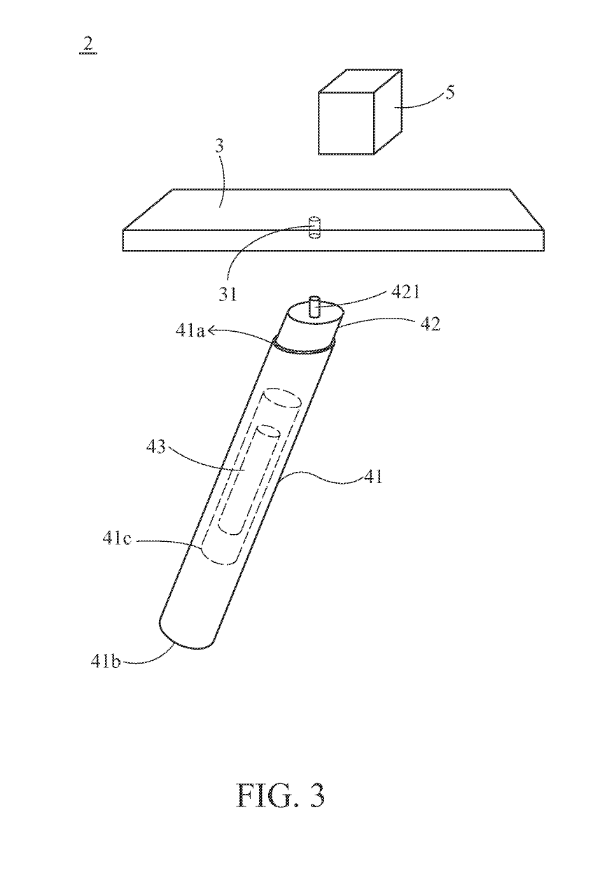

A first embodiment of an impact generating assembly 2 according to the present invention is shown in FIG. 2. The impact generating assembly 2 comprises an impact platform 3 and a plurality of impact generating units 4, and a test object 5 is adapted to be disposed on the impact platform 3 to be subjected to an impact test. With reference also to FIG. 3, each of the impact generating units 4 comprises a holder portion 41, a fixture device 42 and an impact generating portion 43. The holder portion 41 has a first inclined plane 41a and a second inclined plane 41b opposite the first inclined plane 41a, and as shown in FIG. 3, the first inclined plane 41a and the second inclined plane 41b include an angle of 0°˜90° therebetween.

In reference to FIG. 3, the fixture device 42 is disposed on the first inclined surface 41a of the holder portion 41 in the first embodiment, and preferably, the holder portion 41 and the fixture device 42 are integrally formed. The fixture device 42 preferably could be a buckle device, a screwing device or some other equivalent structures with a buckling or screwing function. When the holder portion 41 and the fixture device 42 are integrally formed as shown in FIG. 3, a protrusion 421 of the fixture device 42 is adapted to mate with a buckling groove 31 of the impact platform 3 to fix the impact generating unit 4 to the impact platform 3. Additionally, through the cooperation of the protrusion 421 and the buckling groove 31, the impacting direction in which the impact platform 3 is impacted by the holder portion 41 can be adjusted. It shall be appreciated that the term “fix” used herein refers to a non-permanent construct, so an original impact generating unit may be detached as a module and readily replaced by another impact generating unit with a specific inclination angle and specific impacting parameters depending on the practical needs to accomplish the purpose of customization.

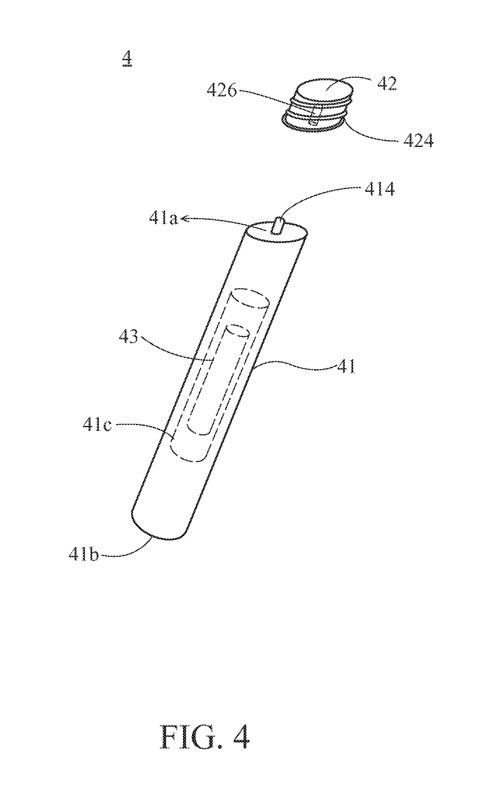

FIG. 4 shows another example of the impact generating unit 4. As shown, a recessed portion 426 of the fixture device 42 mates with a tenon joint 414 on the first inclined plane 41a of the holder portion 41. This, in combination with a screwing structure 424 of the fixture device 42, can fix the impact generating unit 4 to the impact platform 3.

Specifically, to provide an accurate impacting force, the impact generating portion 43 in the first embodiment of the impact generating assembly 2 preferably could be an electric impact generator. As shown in FIG. 2 and FIG. 3, when being disposed inside a receiving space 41c of the holder portion 41, the impact generating portion 43 (i.e., the electric impact generator) is adapted to provide a reciprocating motion in the receiving space 41c in response to slight variations of the current. The reciprocating motion provides an impacting force necessary for driving the holder portion 41 so that a synchronous vibration that is parallel to the horizontal plane is produced on the impact platform 3 for the impact testing procedure. Moreover, the fixture device 42 may further be formed integrally with the first inclined plane 41a to save fabrication cost and increase the structural strength.

Next, a second embodiment of the impact generating assembly 2 according to the present invention will be described.

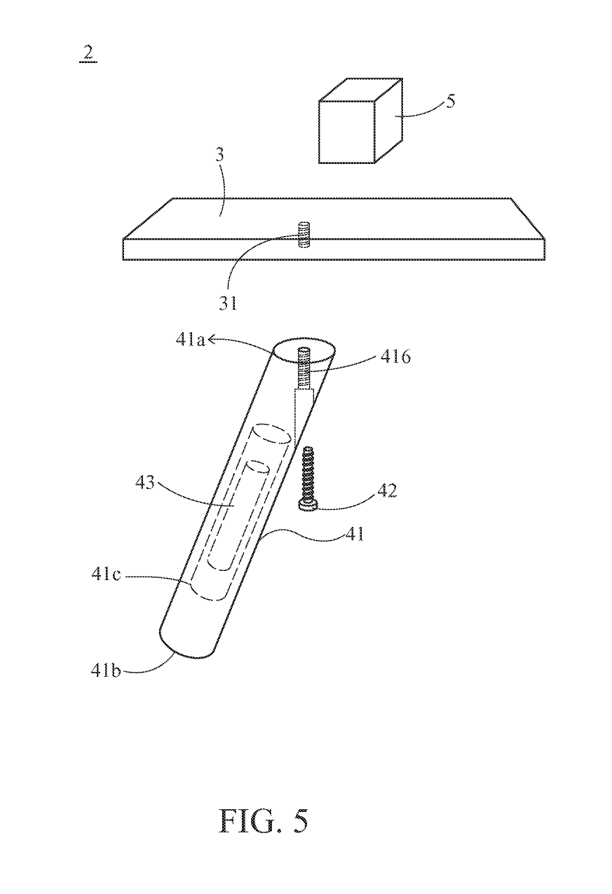

As shown in FIG. 5, elements disclosed in the second embodiment are mainly similar to those of the first embodiment except that the fixture device 42 is not disposed on the first inclined plane 41a of the holder portion 41 and is replaced by a screw which is threaded into a screw hole 416 formed inside the holder portion 41 to fix the holder portion 41 with the impact platform 3. More specifically, the fixing device 42 in this embodiment is a screw that can be sequentially threaded into the screw hole 416 of the holder portion 41 and the buckling groove 31 of the impact platform 3 to fix the holder portion 41 to the impact platform 3. In this way, when the holder portion 41 of different specifications is to be used for the impact testing, it is only necessary to unscrew the fixture device 42 and replace the original holder portion 41 with the desired one. The functions of the other elements are similar and have been mentioned while describing the first embodiment, so no further description will be made herein again.

Next, a third embodiment of the impact generating assembly 2 according to the present invention will be described.

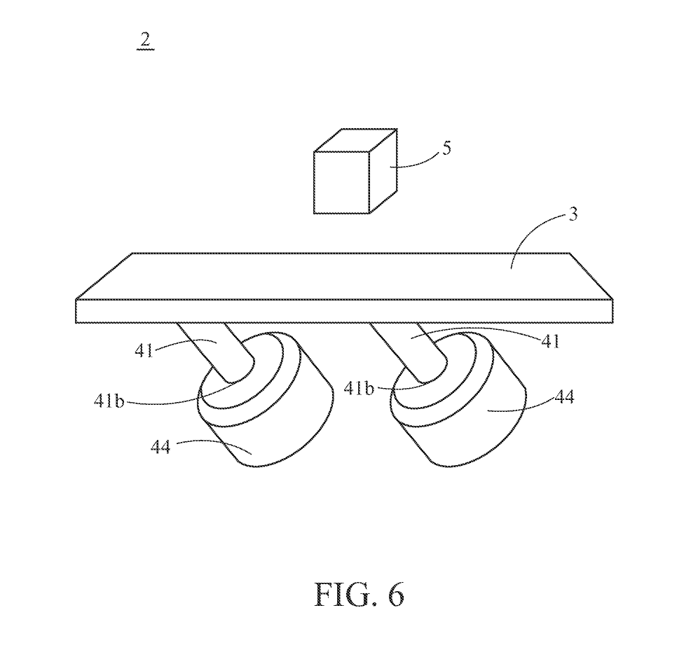

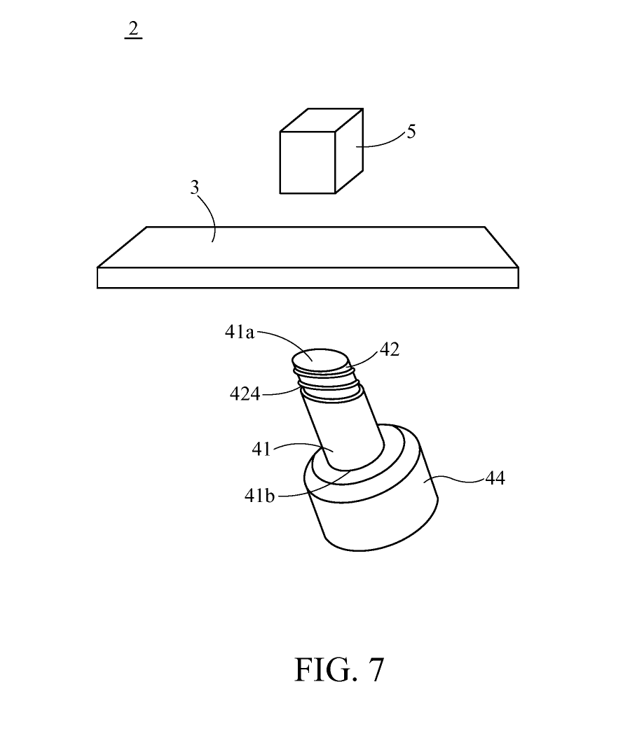

In reference to both FIGS. 6 and 7, the third embodiment of the impact generating assembly 2 according to the present invention is shown therein. Similar to the first embodiment, the impact generating assembly 2 comprises an impact platform 3 and a plurality of impact generating units 4. The test object 5 is adapted to be disposed on the impact platform 3 to be subjected to impact testing. Each of the impact generating units 4 comprises a holder portion 41, a fixture device 42 and an impact generating portion 44. The holder portion 41 has a first inclined plane 41a and a second inclined plane 41b opposite the first inclined plane 41a. The first inclined plane 41a and the second inclined plane 41b include an angle of 0°˜90° therebetween.

The impact generating portion 44 of the third embodiment preferably could be a micro vibration motor. Accordingly, the third embodiment differs from the two previous embodiments in that the impact generating portion 44 (i.e., the micro vibration motor) of the third embodiment needs to be disposed on the second inclined plane 41b of the holder portion 41. Then, when the impact generating portion 44 is energized by a current to produce a reciprocating motion, the holder portion 41 is impelled to produce a synchronous vibration that parallel the horizontal plane on the impact platform 3, thus accomplishing the impact testing.

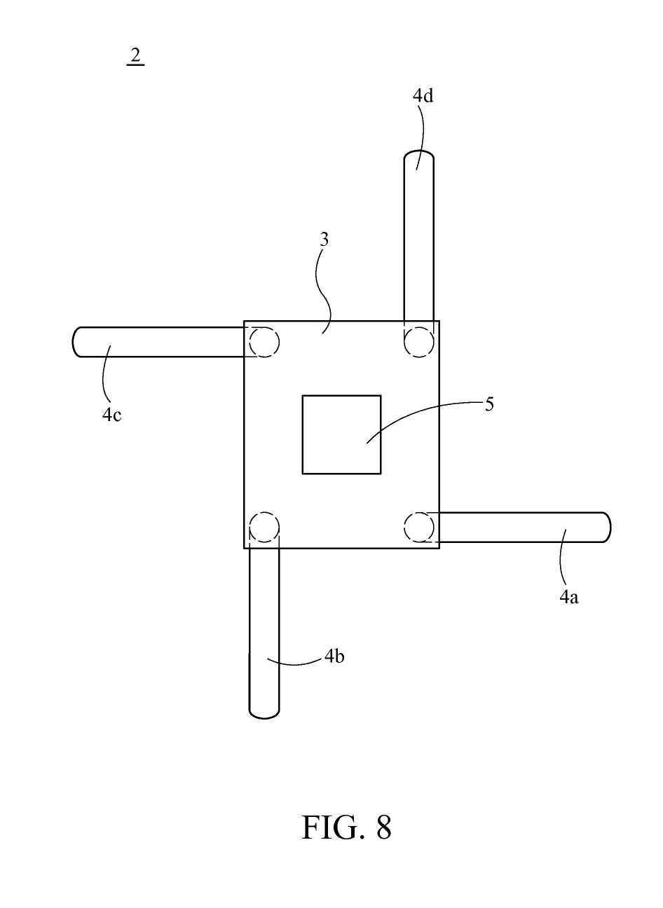

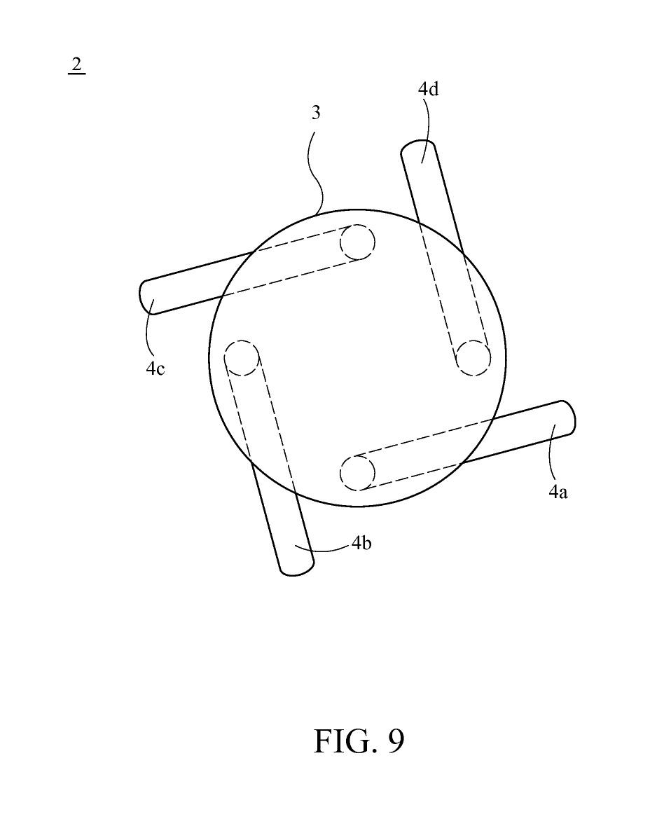

The impact generating assemblies described in the previous embodiments are not limited to having a plurality of impact generating units, so they may comprise only a single impact generating unit fixed to the impact platform. Furthermore, because the impact generating assembly of the present invention allows for the adjustment of the directions or angles of the impact generating units depending on the practical testing requirements, the impact generating assembly 2 may also be embodied as the fourth embodiment and fifth embodiment as shown in FIG. 8 and FIG. 9 respectively.

As shown in the top view of FIG. 8, the four impact generating units 4a, 4b, 4c and 4d are disposed at four corners of the impact platform 3 respectively. The four impact generating units 4a, 4b, 4c and 4d are disposed directionally different from each other, but all include an identical included angle (not shown) with the impact platform 3. With this arrangement, when the four impact generating units 4a, 4b, 4c and 4d each generate a reciprocating movement, component forces will be generated in the X-axis direction, the Y-axis direction and the Z-axis direction respectively. A resulting force thus generated can not only drive the impact platform 3 to produce a synchronous vibration, but also provide the impact platform 3 with a twisting movement in the center point of the four impact generating units 4a, 4b, 4c and 4d. Thereby, a twisting force test can be additionally made on the test object 5 to more realistically simulate the practical conditions of the test object.

FIG. 9 shows a fifth embodiment of the present invention. The four impact generating units 4a, 4b, 4c and 4d of the fifth embodiment are arranged in similarly to those of the fourth embodiment, i.e., the four impact generating units 4a, 4b, 4c and 4d are disposed beneath the impact platform 3 and every two opposite ones are symmetrical with each other. The impact platform 3 is a circular impact platform. In other words, when the impact generating units 4a, 4b, 4c and 4d of this embodiment are mounted in the form of modules to the circular impact platform 3, a component forces in the X-axis direction, the Y-axis direction and the Z-axis direction as well as a twisting moment for turning the impact platform 3 can be generated by simply disposing the impact generating units 4a, 4b, 4c and 4d symmetrically with respect to the center point without disposing them at the four corners of the impact platform 3 as in the fourth embodiment shown in FIG. 8.

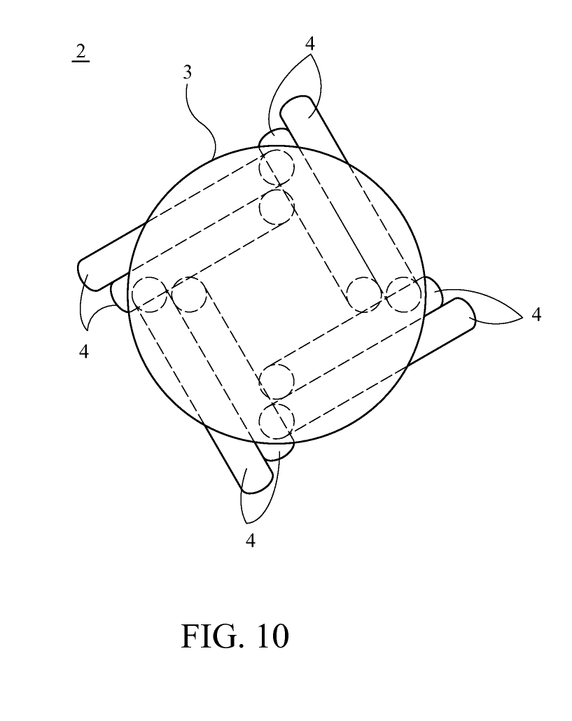

A sixth embodiment of the impact generating unit 4 according to the present invention is shown in FIG. 10. In this embodiment, eight impact generating units 4 are disposed in groups of two beneath the impact platform 3, with every two groups being opposite to each other with respect to the center of the circular impact platform 3. When applying an impact, one of the two impact generating units 4 in each group firstly produce an impacting force to the impact platform 3; then when the impact platform 3 that has been impacted by this impacting force is restored back to its original position, the other impact generating unit 4 in each group will produce another impacting force to the impact platform 3. In other words, each group of impact generating units 4 applies a stable impacting force to the impact platform 3 intermittently so that a reciprocating movement of the impact platform 3 is produced. Of course, besides the implementations shown therein, additional impact generating units 4 may also be disposed on the impact platform. The generating units 4 could be added flexibly in the spot where the stress is insufficient depending on practical needs. Thereby, the purpose of readily adjusting the impacting angles or directions depending on the testing requirements and of readily changing the number of impact generating units can be achieved.

The above disclosure is related to the detailed technical contents and inventive features Thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An impact generating unit for use on an impact platform, comprising:
a holder portion comprising a first inclined plane and a second inclined plane opposite the first inclined plane;
a fixture device disposed on the holder portion, and the holder portion is detachably mounted to the impact platform; and
an impact generating portion disposed on the holder portion and adapted to provide a reciprocating motion;
wherein the first inclined plane of the holder portion is mounted to the impact platform by the fixture device, and the impact generating portion is adapted to produce a synchronous vibration on the impact platform through the holder portion.

2. The impact generating unit as claimed in claim 1, wherein the first inclined plane and the second inclined plane include an angle of 0°˜90° therebetween.

3. The impact generating unit as claimed in claim 1, wherein the impact generating portion is a micro vibration motor or an electric impact generator.

4. The impact generating unit as claimed in claim 1, wherein the reciprocating motion is substantially parallel to a horizon plane.

5. The impact generating unit as claimed in claim 1, wherein the fixture device is a screw device or a buckle device.

6. The impact generating unit as claimed in claim 1, wherein the holder portion further comprises a screw hole for receiving the fixture device.

7. The impact generating unit as claimed in claim 6, wherein the fixture device is a screw.

8. The impact generating unit as claimed in claim 1, wherein the impact generating portion is disposed on the second inclined plane of the holder portion.

9. The impact generating unit as claimed in claim 1, wherein the impact generating portion is disposed inside an inner space of the holder portion.

10. The impact generating unit as claimed in claim 1, wherein the fixture device comprises a recess portion, the first inclined plane of the holder portion comprises a protrusion, and the recess portion is adapted to be mounted with the protrusion.

11. The impact generating unit as claimed in claim 1, wherein the fixture device is formed integrally with the holder portion.

12. An impact generating assembly comprising:
an impact platform; and
a plurality of impact generating units, wherein each of the impact generating units comprises:
a holder portion comprising a first inclined plane and a second inclined plane opposite the first inclined plane;
a fixture device disposed on the holder portion, and the holder portion is detachably mounted to the impact platform; and
an impact generating portion disposed on the holder portion and adapted to provide a reciprocating motion;
wherein the impact generating units are mounted to the impact platform by the fixture devices, and the impact generating portions are adapted to produce a synchronous vibration on the impact platform through the holder portions.
